(19) United States
(12) Patent Application Publication
(10) Pub. No.: US 2010/0264557 A1
(43) Pub. Date: Oct. 21, 2010

(54) MOLD FOR INJECTION MOLDING

(76) Inventors: Chien-Yuan Ni, TAIPEI CITY (TW); Hsin-Hsiu Tsai, TAIPEI CITY (TW)

Correspondence Address: NORTH AMERICA INTELLECTUAL PROPERTY CORPORATION, P.O. BOX 506, MERRIFIELD, VA, 22116, US

(21) Appl. No.: 12/762,391

(22) Filed: Apr. 19, 2010

(30) Foreign Application Priority Data
Apr. 20, 2009 (TW) 098113017

(51) Int. Cl. B29C 45/36; B29C 45/00; B29C 45/40

(52) U.S. Cl. 264/39; 425/542; 425/556

(57) ABSTRACT

A mold for injection molding includes a first mold core, a base, a mold core base, a second mold core, and a plurality of first screws. The mold core base is disposed at the base. The second mold core is disposed at the mold core base. When the first mold core approaches the second mold core, the first mold core and the second mold core form a mold cavity. The first screws pass through the mold core base from a side of the mold core base away from the base to be screwed into the base.

### CROSS-REFERENCE TO RELATED APPLICATIONS

This Non-provisional application claims priority under 35 U.S.C. §119(a) on Patent Application No(s). 098113017 filed in Taiwan, Republic of China on Apr. 20, 2009, the entire contents of which are hereby incorporated by reference.

### BACKGROUND OF THE INVENTION

1. Field of the Invention

This invention relates to a mold for injection molding and, more particularly, to a mold capable of being disassembled and stored easily.

2. Description of the Related Art

Plastic molding products are used for daily articles, electronic products, industrial products and so on, and they are necessary tools in present industrial circles. FIG. 1 is a sectional diagram showing a conventional mold. In FIG. 1, a mold includes a first mold core 120, a second mold core 115 cooperating with the first mold core 120, a base 111, two ejecting plates 112, 113, a mold core base 114, a plurality of ejecting inclined pins 116, a plurality of guiding posts 117, at least one mold core retaining block 118, and a plurality of screws 121, 122, 123, and 124.

The mold core base 114 is disposed at the base 111, and the second mold core 115 is fixed to the mold core base 114 by the mold core retaining block 118 and the screws 123, 124. The ejecting plates 112, 113 are fixed to each other via the screw 122 thus to be disposed at the base 111. The screw 121 passes through the base 111 from a side of the base 111 away from the mold core base 114 to be screwed into the mold core base 114. The guiding posts 117 are disposed through the base 111, the ejecting plates 112, 113, and the mold core base 114. Ends of the ejecting inclined pins 116 are fixed to the ejecting plate 112 and disposed through the ejecting plate 112, the mold core base 114, and the second mold core 115.

In the mold 100, to take out the second mold core 115 from the mold core base 114, a user needs to disassemble components of the mold 100 one by one. FIG. 2A to FIG. 2G are schematic diagrams showing disassembly of the mold 100 in FIG. 1. First, as shown in FIG. 2A, the first mold core 120 is removed. Then, in FIG. 2B and FIG. 2C, after the direction of the second mold core 115 is changed, the guiding posts 117 and the screw 121 are taken out, respectively. Then, as shown in FIG. 2D and FIG. 2E, the base 111 is separated from the ejecting plates 112, 113, and the ejecting plate 113 is disassembled from the ejecting plate 112 by unscrewing the screw 122. In FIG. 2F, the ejecting inclined pin 116 includes a pole 116a and an inclined pin part 116b, and the pole 116a is taken out from the inclined pin part 116b. Finally, as shown in FIG. 2G, after the screw 123, the mold core retaining block 118, and the screw 124 are removed in turn, the second mold core 115 can be removed from the mold core base 114.

According to the above disassembling steps, the steps of disassembling the mold are complicated and the number of components is great. Once the mold needs to be adjusted or maintained, a lot of efforts and time may be consumed for disassembly to take out the second mold core 115. Further, the kinds and number of the components after the mold is disassembled are great, which increases difficulty in storing and managing the components.

### BRIEF SUMMARY OF THE INVENTION

This invention provides a mold for injection molding capable of being disassembled easily and stored conveniently.

The invention provides a method for disassembling a mold for injection molding having simple disassembling steps.

This invention provides a mold including a first mold core, a base, a mold core base, a second mold core, and a plurality of first screws. The mold core base is disposed at the base. The second mold core is disposed at the mold core base. When the first mold core approaches the second mold core, the first mold core and the second mold core form a mold cavity. The first screws pass through the mold core base from a side of the mold core base away from the base to be screwed into the base.

In one embodiment of the invention, the base may include a base plate and a plurality of spacing blocks. The spacing blocks are disposed at one side of the base plate, and the first screws screw the mold core base to the spacing blocks thus to allow the mold core base to be disposed at the base.

In one embodiment of the invention, the mold may further include a plurality of second screws passing through the base plate from the other side of the base plate to be screwed into the spacing blocks.

In one embodiment of the invention, the base may further include an ejecting plate and a plurality of molding elements. The ejecting plate is disposed at the base plate. The molding elements pass through the base plate, the ejecting plate, the mold core base, and the second mold core.

In one embodiment of the invention, the mold may further include a plurality of ejecting inclined pins. The base has a plurality of through holes. The ejecting inclined pins pass through the ejecting plate, the mold core base, and the second mold core. Each of the ejecting inclined pins includes an inclined pin part, a pole, and a third screw. The inclined pin part has a groove. One end of the pole has a protrudent structure, and the shape of the protrudent structure corresponds to that of the groove. The protrudent structure is embedded into the groove to allow the pole to be connected with the inclined pin part. The third screw passes through one of the through holes and screws the pole to the ejecting plate.

In one embodiment of the invention, the second mold core may have a plurality of conical through holes for guiding the molding elements.

In one embodiment of the invention, each of the molding elements may include a pin and a sleeve. One end of the pin is fixed to the base. The sleeve is sleeved on the pin, and one end of the sleeve is fixed to the ejecting plate.

In one embodiment of the invention, the mold may include a mold core retaining block and a fourth screw. The mold core retaining block is screwed to the mold core base via the fourth screw, and the mold core retaining block is located adjacent to the second mold core to allow the second mold core to be tightly against the mold core base.

The invention further provides a mold disassembling method for disassembling the aforementioned mold. The mold disassembling method includes the following steps. The first mold core is removed first, and then the first screws are unscrewed. Then, the mold core base is separated from the base and a plurality of cushion blocks are provided to be disposed between the mold core base and the base. Finally, the second mold core is disassembled from the mold core base.

In one embodiment of the invention, the base may include a base plate, an ejecting plate, and a plurality of molding elements. The ejecting plate is disposed at the base plate. The molding elements pass through the base plate, the ejecting plate, the mold core base, and the second mold core. When the cushion blocks are disposed between the mold core base and the base, ends of the molding elements adjacent to the second mold core are embedded into the mold core base.

In one embodiment of the invention, the base may have a plurality of through holes, and the mold may further include a plurality of ejecting inclined pins passing through the ejecting plate, the mold core base, and the second mold core. Each of the ejecting inclined pins includes an inclined pin part, a pole, and a third screw. The third screw passes through one of the through holes and screws the pole to the ejecting plate. The mold disassembling method further includes the following steps. The third screws are first unscrewed and removed from the through holes to allow the inclined pin parts to partly protrude from the second mold core. Then, the inclined pin parts and the poles are taken out from the side adjacent to the second mold core.

In one embodiment of the invention, the mold may be used for molding a plastic element, and the height of the cushion blocks may be equal to the sum of that of the second mold core and the plastic element.

In one embodiment of the invention, the mold may further include at least one mold core retaining block and at least one fourth screw. The mold core retaining block is screwed to the mold core base via the fourth screw, and the mold core retaining block is located adjacent to the second mold core to allow the second mold core to be tightly against the mold core base. Before the step of disassembling the second mold core from the mold core base, the mold disassembling method further includes the following steps. The fourth screw is unscrewed first, and then the mold core retaining block is removed from the mold core base.

To sum up, according to the mold and the mold disassembling method thereof in the invention, since the first screws are screwed into the base by passing through the mold core base from the side of the mold core base away from the base, when a user disassembles the mold, the user can disassemble the second mold core from the mold core base after unscrewing the first screws and screwed screws of the ejecting inclined pins. Thus, the conventional complicated mold disassembling process is simplified. Further, since the mold still maintains integrity in assembly, the mold can be conveniently stored and managed.

These and other features, aspects, and advantages of the present invention will become better understood with regard to the following description, appended claims, and accompanying drawings.

### BRIEF DESCRIPTION OF THE DRAWINGS

FIG. 1 is a sectional diagram showing a conventional mold;

FIG. 2A to FIG. 2G are schematic diagrams showing disassembly of the mold in FIG. 1;

FIG. 3 is a sectional diagram showing a mold according to one embodiment of the invention;

FIG. 4 is an enlarged diagram showing an A part of the mold in FIG. 3;

FIG. 5 is an exploded diagram showing an ejecting inclined pin of the mold in FIG. 3;

FIG. 6 is a flow chart showing disassembly of the mold in FIG. 3; and

FIG. 7A to FIG. 7G are schematic diagrams corresponding to the mold disassembling flow path in FIG. 6.

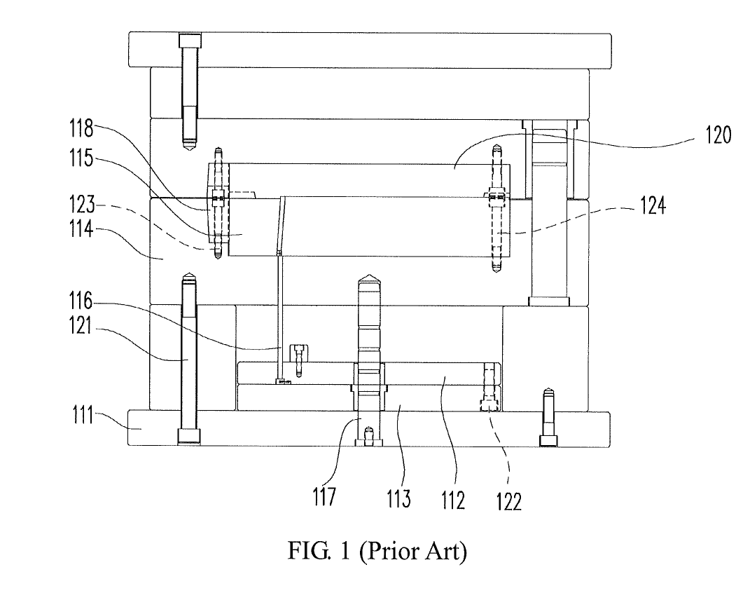

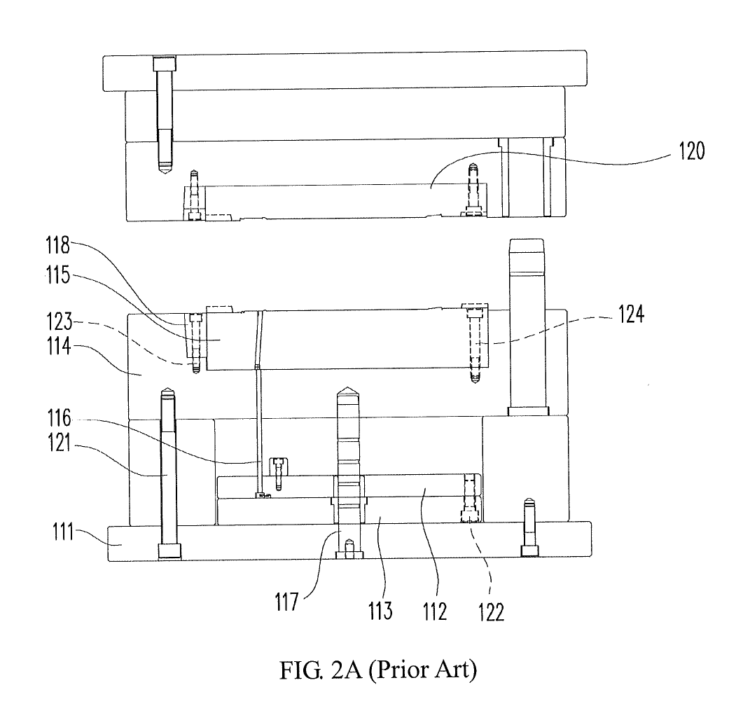

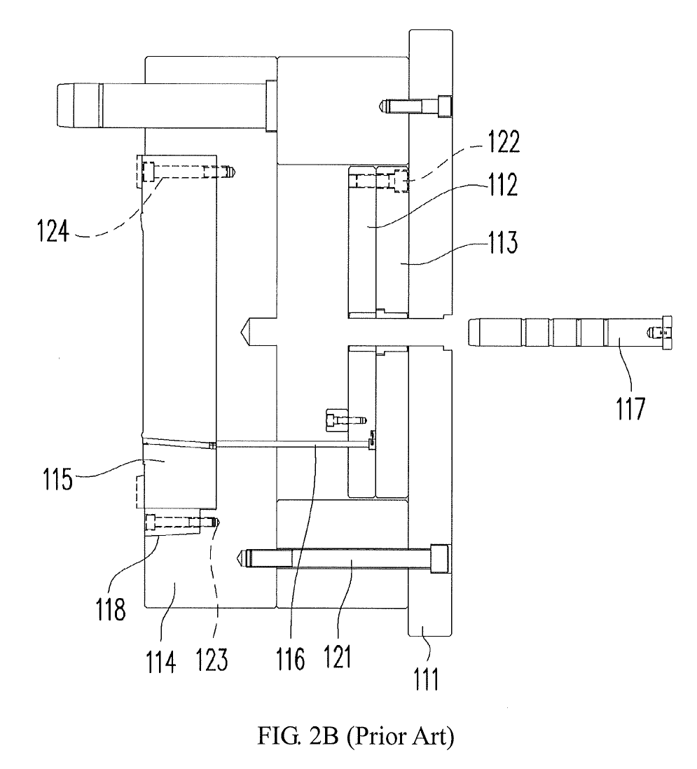

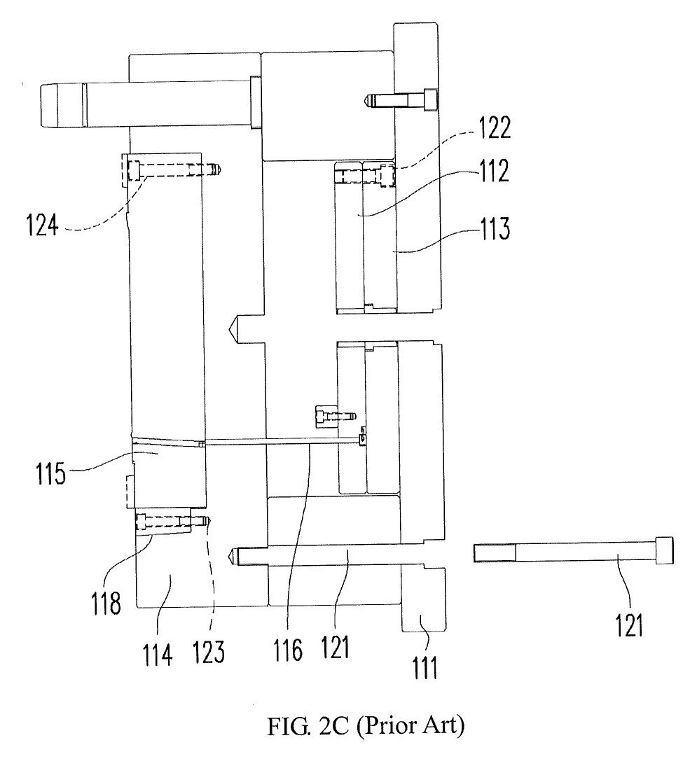

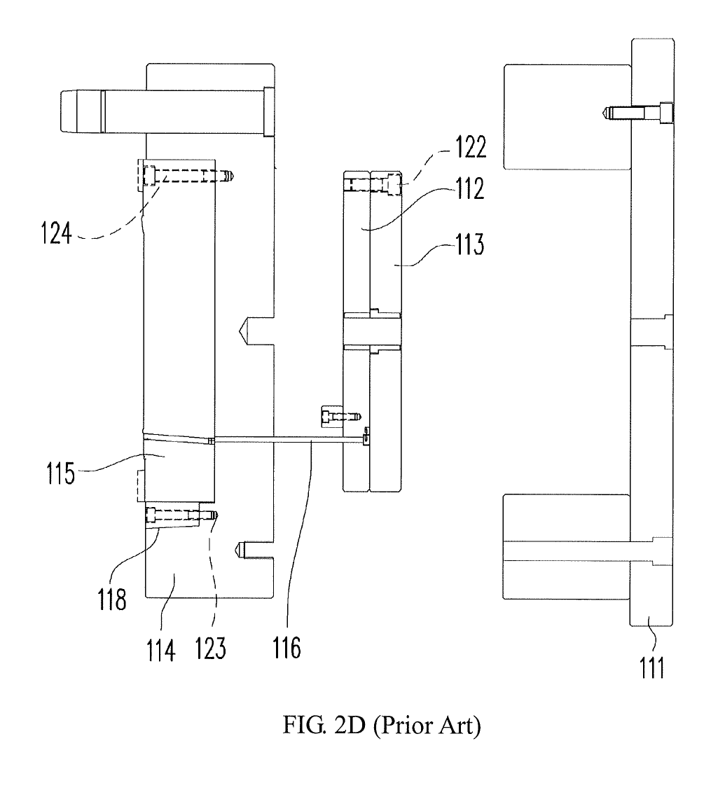

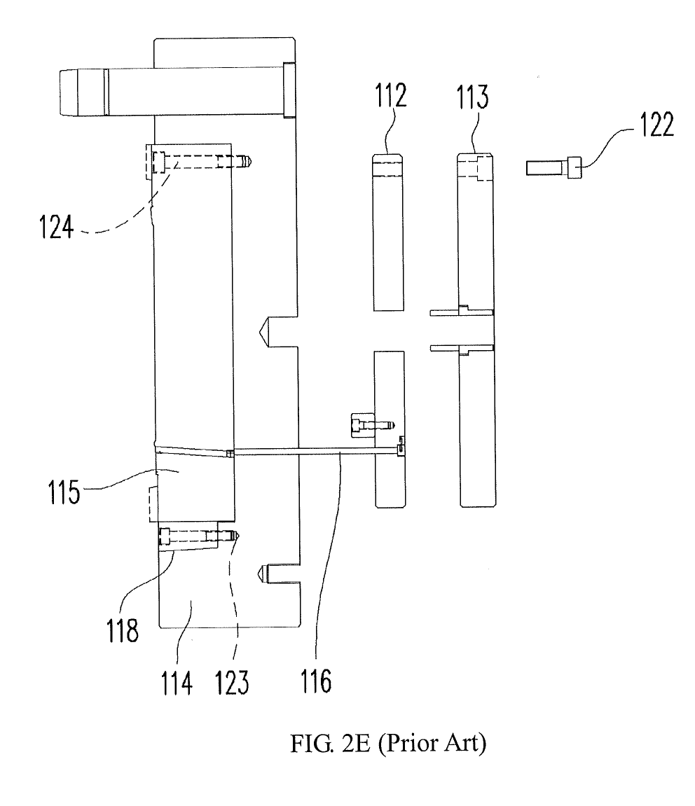

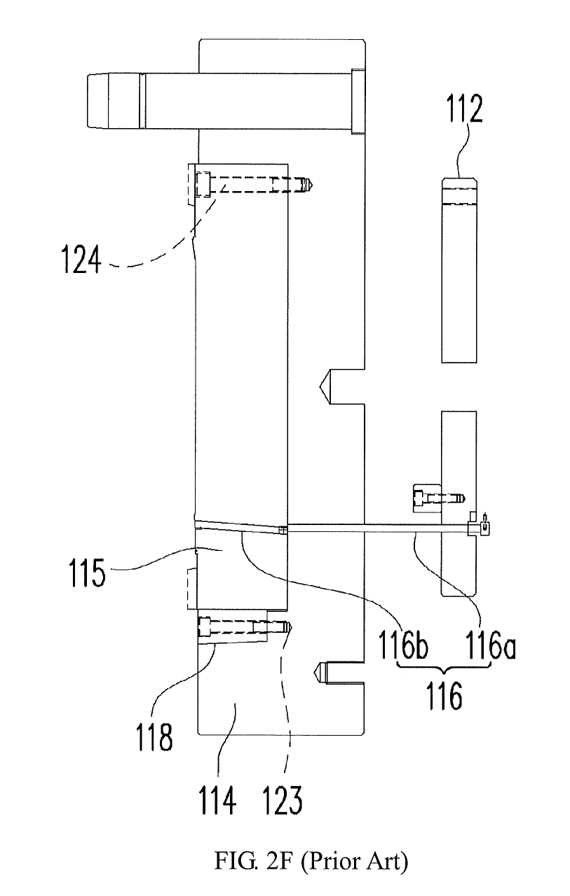

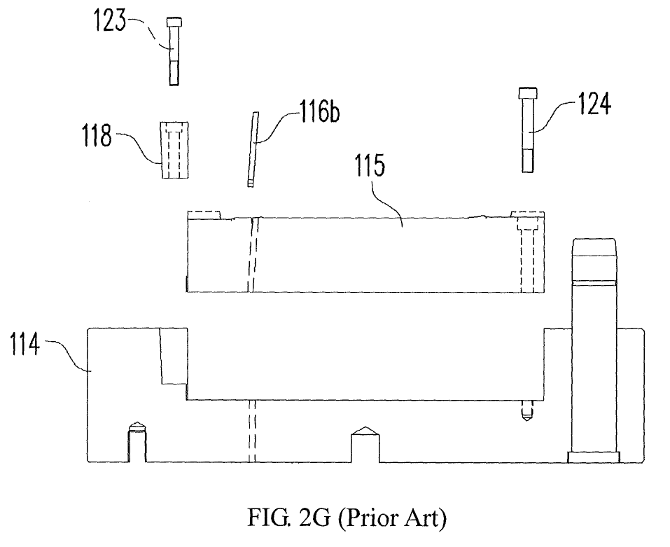

### DETAILED DESCRIPTION OF THE INVENTION

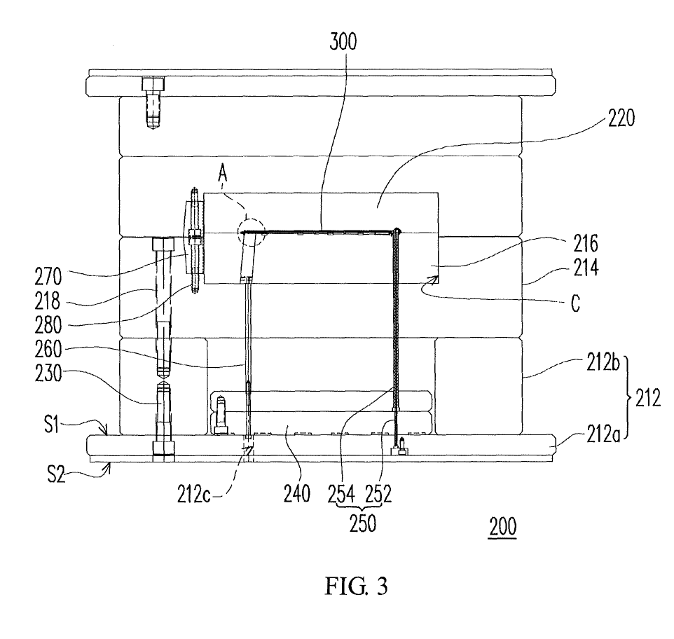

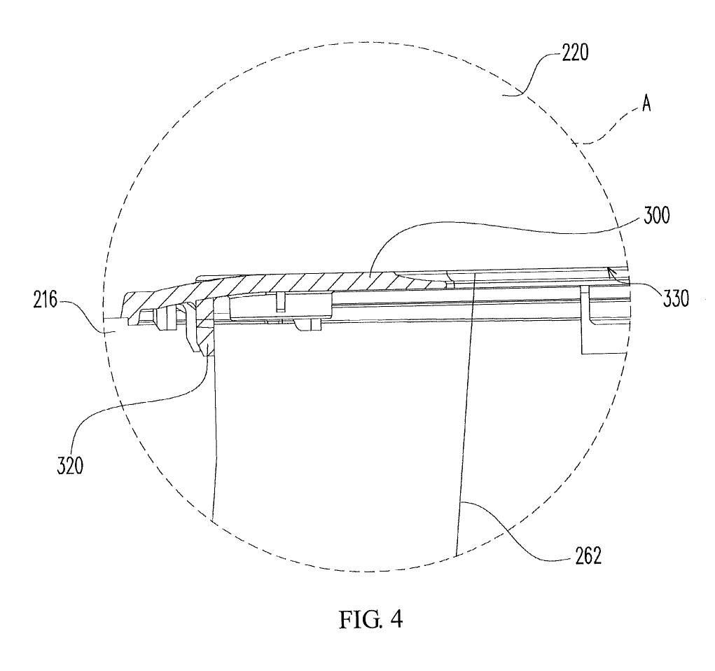

FIG. 3 is a sectional diagram showing a mold according to one embodiment of the invention. FIG. 4 is an enlarged diagram showing an A part of the mold in FIG. 3. Please refer to FIG. 3 and FIG. 4 together. A mold 200 includes a first mold core 220, a base 212, a mold core base 214, a second mold core 216, and a plurality of first screws 218. The mold core base 214 is disposed at the base 212. The second mold core 216 is disposed at the mold core base 214. When the first mold core 220 approaches the second mold core 216, the first mold core 220 and the second mold core 216 form a mold cavity 330, such that plastic can be injected by a molding machine (not shown) and can form a plastic element 300 after cooled. The first screws 218 pass through the mold core base 214 from a side of the mold core base 214 away from the base 212 to be screwed into the base 212.

According to the mold 200 in the embodiment of the invention, since the first screws 218 are screwed into the base 212 from the side of the mold core base 214 away from the base 212, a user can first disassemble the mold 200 from the side adjacent to the second mold core 216, and the user can disassemble the second mold core 216 from the mold core base 214 after unscrewing the first screws 218 and some screwed screws. Compared with the conventional mold 100, as the screwed direction of the first screws 218 is changed, steps of disassembling the mold 200 can be simplified and time can be saved, and the mold 200 can maintain integrity to facilitate management.

Please refer to FIG. 3. In the embodiment, the base 212 includes a base plate 212a and a plurality of spacing blocks 212b. The spacing blocks 212b are disposed at one side S1 of the base plate 212a, and the first screws 218 screw the mold core base 214 to the spacing blocks 212b thus to allow the mold core base 214 to be disposed at the base 212. In addition, the mold 200 further includes a plurality of second screws 230 passing through the base plate 212a from the other side S2 of the base plate 212a to be screwed into the spacing blocks 212b. The second screws 230 face the first screws 218, such that the mold core base 214 and the base 212 are combined with and fixed to each other.

On the other hand, the base 212 further includes an ejecting plate 240 and a plurality of molding elements 250. The ejecting plate 240 is disposed at the base plate 212a. The molding elements 250 pass through the base plate 212a, the ejecting plate 240, the mold core base 214, and the second mold core 216. After the plastic element 300 is molded and cooled, once the mold 200 is opened, the plastic element 300 can be left at the second mold core 216. At that moment, the ejecting plate 240 is pushed by pushing force of an ejecting mechanism (not shown) of the molding machine and drives the molding elements 250 to move forward, such that the plastic element 300 can be separated from the mold 200.

In the embodiment, since the plastic element 300 has a boss, the mold 200 needs a sleeve to allow the plastic element 300 to be successfully separated. Therefore, each of the molding elements 250 includes a pin 252 and a sleeve 254. One end of the pin 252 is fixed to the base plate 212a. The sleeve 254 is sleeved on the pin 252, and one end of the sleeve 254 is fixed to the ejecting plate 240. After the mold 200 is opened, the ejecting plate 240 can drive the sleeve 254 to move forward, such that the boss of the plastic element 300 is smoothly ejected by the sleeve 254.

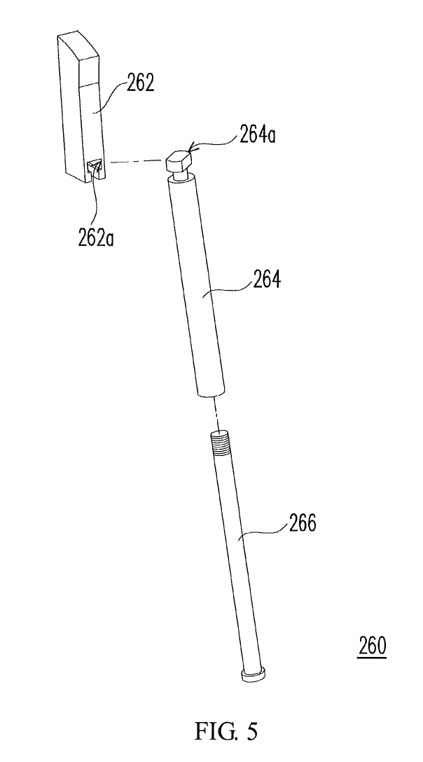

FIG. 5 is an exploded diagram showing an ejecting inclined pin of the mold 200 in FIG. 3. Please refer to FIG. 3 and FIG. 5 together. The base 212 has a plurality of through holes 212c, and the mold 200 further includes a plurality of ejecting inclined pins 260 passing through the ejecting plate 240, the mold core base 214, and the second mold core 216. Each of the ejecting inclined pins 260 includes an inclined pin part 262, a pole 264, and a third screw 266. The inclined pin part 262 has a groove 262a. One end of the pole 264 has a protrudent structure 264a, and the shape of the protrudent structure 264a corresponds to that of the groove 262a. The protrudent structure 264a is embedded into the groove 262a to allow the pole 264 to be connected with the inclined pin part 262. The third screw 266 passes through one of the through holes 212c of the base 212 and screws the pole 264 to the ejecting plate 240.

Please refer to FIG. 4. In the embodiment, a surface of the plastic element 300 has a concave and convex profile such as an L-shaped barb 320. Therefore, to prevent the interference between the plastic element 300 and the second mold core 216 caused by the L-shaped barb 320 from damaging the plastic element 300 when the molding elements 250 eject the plastic element 300, the ejecting inclined pins 260 need to provide lateral force to assist the plastic element 300 during the mold-parting process. When the mold 200 is opened, the ejecting inclined pins 260 first drive the plastic element 300 to move together to be separated from the mold 200, and then the molding elements 250 eject the plastic element 300 thus to allow the plastic element 300 to be separated from the ejecting inclined pins 260.

Please refer to FIG. 3. In the embodiment, the mold 200 further includes at least one mold core retaining block 270 and at least one fourth screw 280. The mold core retaining block 270 is screwed to the mold core base 214 via the fourth screw 280, and the mold core retaining block 270 is located adjacent to the second mold core 216 to allow the second mold core 216 to be tightly against a lateral surface C of the mold core base 214, such that the lateral surface C becomes a reference surface during molding the plastic element 300, assembling the mold 200, and repairing the second mold core 216. The number of the mold core retaining block 270 and the fourth screw 280 is not limited in the invention herein. The user can increase or decrease the mold core retaining block 270 and the fourth screw 280 according to mold design needs.

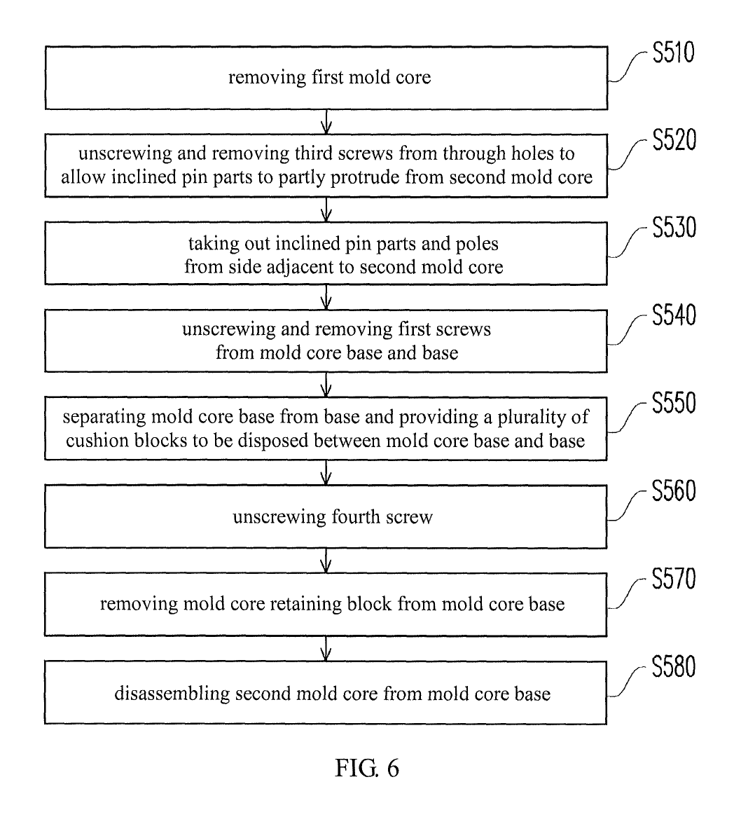

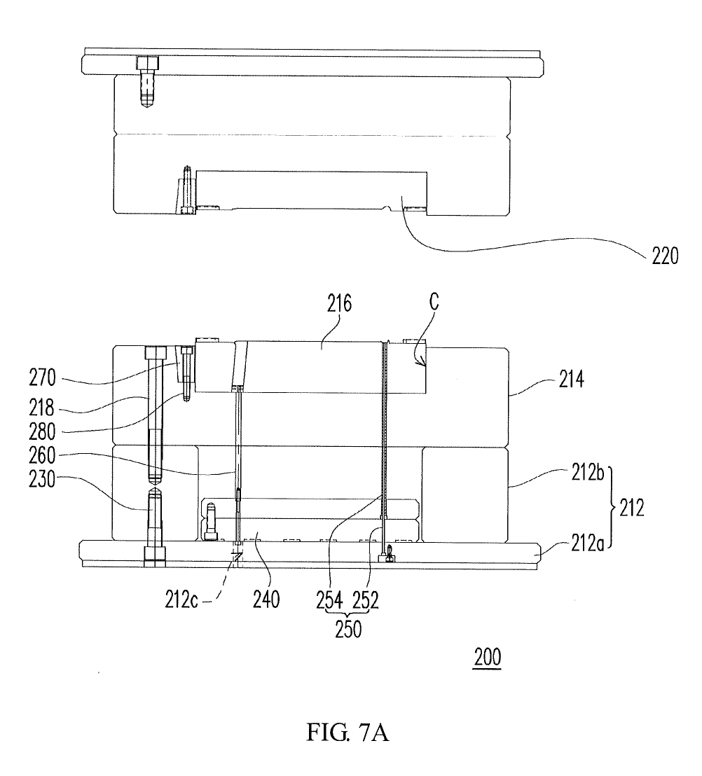

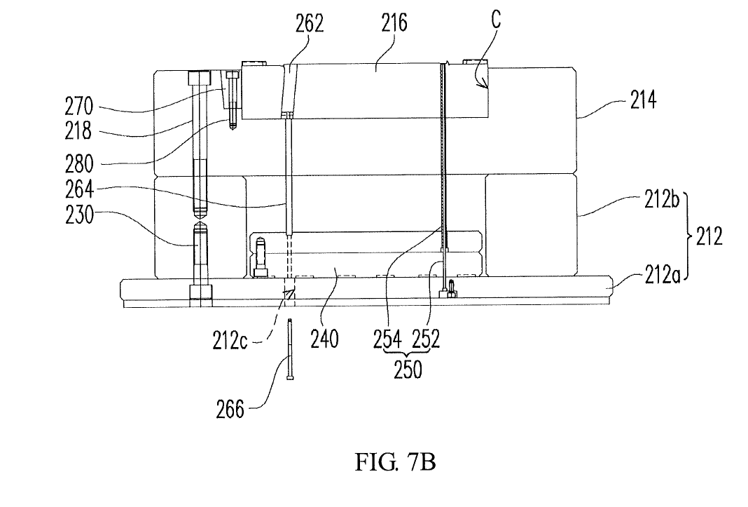

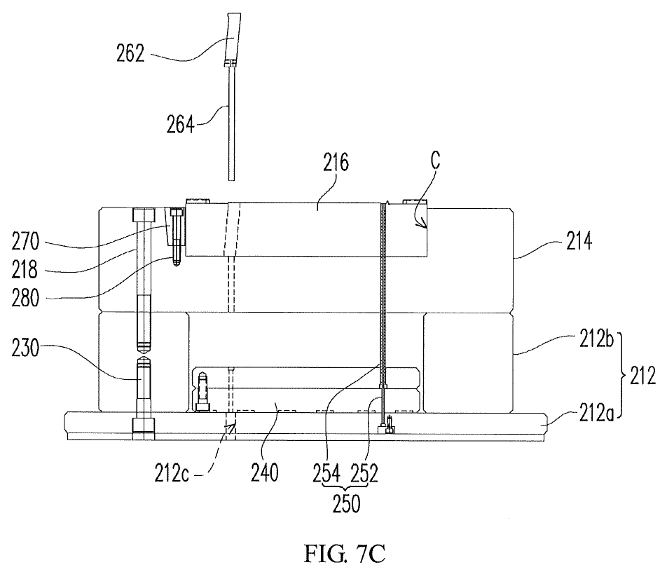

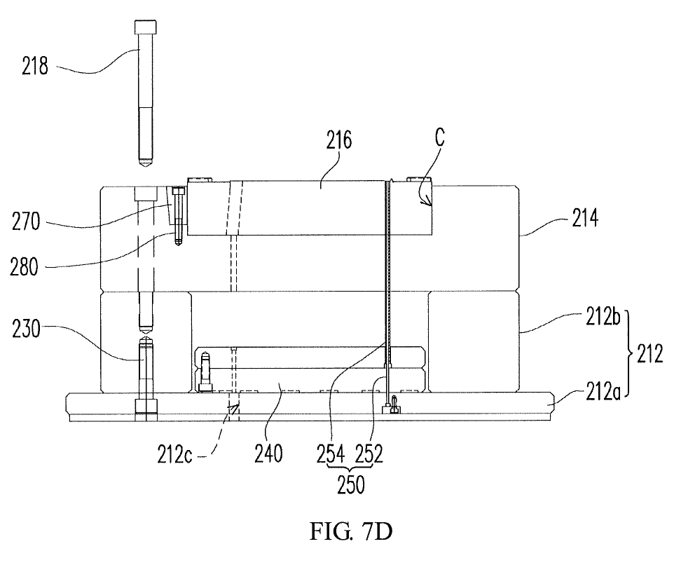

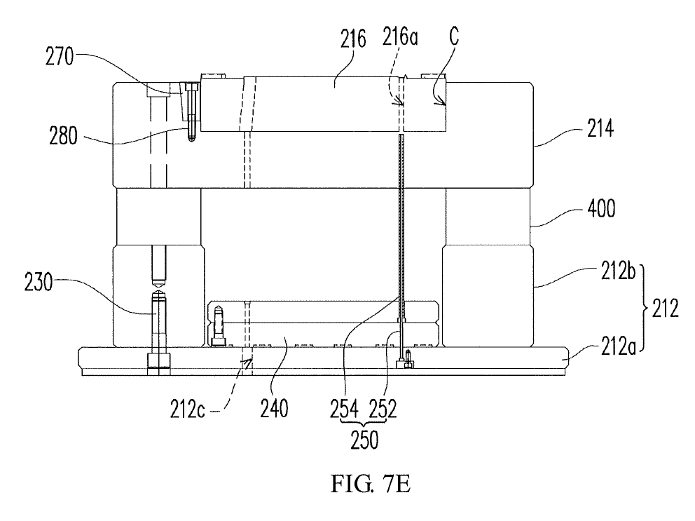

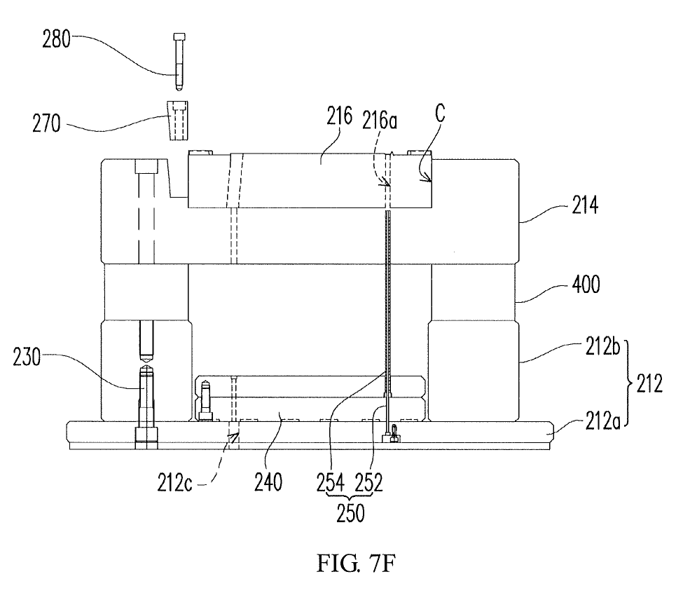

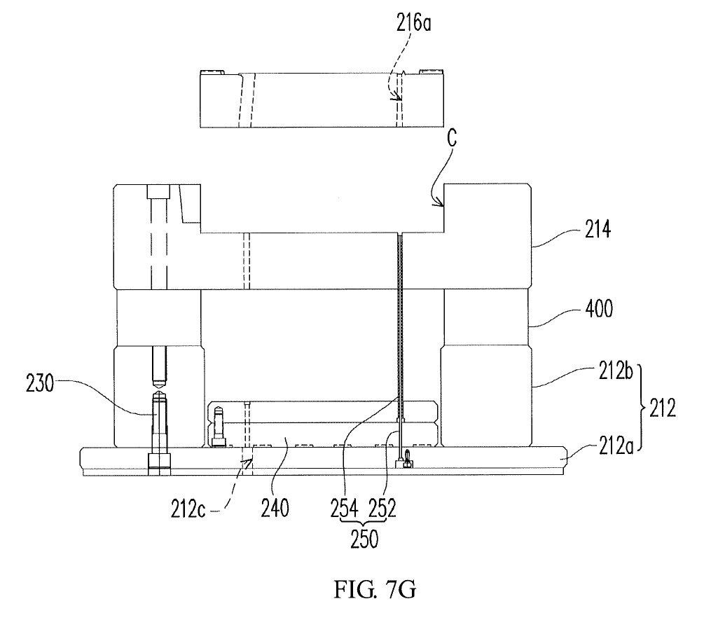

The invention further provides a mold disassembling method for disassembling the mold 200. FIG. 6 is a flow chart showing disassembly of the mold 200 in FIG. 3. FIG. 7A to FIG. 7G are schematic diagrams corresponding to the mold disassembling flow path in FIG. 6. Please refer to FIG. 6 and FIG. 7A to FIG. 7G together. The disassembling method of the mold 200 is described hereinbelow.

First, in step S510 and FIG. 7A, the first mold core 220 is removed. Then, in step S520 and FIG. 7B, the third screws 266 are unscrewed and removed from the through holes 212c. At the same time, the user can eject the inclined pin parts 262 of the ejecting inclined pins 260 via friction force between threads by rotation of the third screws 266 relative to the poles 264 thus to allow the inclined pin parts 262 to partly protrude from the second mold core 216. In step S530 and FIG. 7C, the inclined pin parts 262 and the poles 264 are taken out from the side adjacent to the second mold core 216. Then, in step S540 and FIG. 7D, the first screws 218 are unscrewed and removed from the mold core base 214 and the base 212.

Further, please refer to step S550 and FIG. 7E. The mold core base 214 is separated from the base 212, and a plurality of cushion blocks 400 are provided to be disposed between the mold core base 214 and the spacing blocks 212b of the base 212. Please further refer to steps S560, S570 and FIG. 7F. The fourth screw 280 is unscrewed and removed, and the mold core retaining block 270 is taken out from the mold core base 214. Finally, in step S580 and FIG. 7G, the second mold core 216 is disassembled from the mold core base 214. In the invention, time of taking out the inclined pin parts 262 and the poles 264 of the ejecting inclined pins 260 is not limited herein. In the embodiment, after the third screws 266 are unscrewed, the inclined pin parts 262 and the poles 264 are taken out from the side adjacent to the second mold core 216. However, in another embodiment which is not shown, the inclined pin part 262 and the pole 264 can be taken out before the step of taking out the second mold core 216 from the mold core base 214.

On the other hand, in FIG. 7E, the second mold core 216 has a plurality of conical through holes 216a. When the second mold core 216 is to be assembled to the mold core base 214, the conical through holes 216a are used for guiding the molding elements 250 thus to prevent the molding elements 250 from directly striking the second mold core 216 to cause damage.

In addition, when the cushion blocks 400 are disposed between the mold core base 214 and the base 212, ends of the molding elements 250 adjacent to the second mold core 216 are embedded into the mold core base 214. Thereby, the molding elements 250 can be protected by the mold core base 214, thus to avoid damage caused by striking during transporting the mold 200. Therefore, in the embodiment, the height of the cushion blocks 400 is equal to the sum of that of the second mold core 216 and the plastic element 300, thus to allow the molding elements 250 to be embedded into the mold core base 214. However, the height of the cushion blocks 400 is not limited in the invention. Any height capable of allowing the ends of the molding elements 250 to be embedded into the mold core base 214 when the mold core base 214 is cushioned is within the scope of the invention.

To sum up, according to the mold and the disassembling method thereof in the embodiment of the invention, the first screws are screwed into the base from the side of the mold core base away from the base. That is, the user can disassemble the second mold core from the mold core base without disassembling the components one by one from one side of the base. Compared with the prior art, the mold in the embodiment of the invention can be easily disassembled and conveniently stored.

In addition, when the mold core base is separated from the base, the mold core base is cushioned by the cushion blocks, such that the ends of the molding elements disposed at the second mold core can be embedded into the mold core base. Thereby, the molding elements of the mold can be protected to avoid damage caused by striking during transporting the mold.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A mold for injection molding comprising:
a first mold core;
a base;
a mold core base disposed at the base;
a second mold core disposed at the mold core base, when the first mold core approaches the second mold core, the first mold core and the second mold core forming a mold cavity; and
a plurality of first screws passing through the mold core base from a side of the mold core base away from the base to be screwed into the base.

2. The mold according to claim 1, wherein the base comprises a base plate and a plurality of spacing blocks, the spacing blocks are disposed at one side of the base plate, and the first screws screw the mold core base to the spacing blocks thus to allow the mold core base to be disposed at the base.

3. The mold according to claim 2, further comprising a plurality of second screws passing through the base plate from the other side of the base plate to be screwed into the spacing blocks.

4. The mold according to claim 2, wherein the base further comprises:
an ejecting plate disposed at the base plate; and
a plurality of molding elements passing through the base plate, the ejecting plate, the mold core base, and the second mold core.

5. The mold according to claim 4, further comprising a plurality of ejecting inclined pins, wherein the base has a plurality of through holes, the ejecting inclined pins pass through the ejecting plate, the mold core base, and the second mold core, and each of the ejecting inclined pins includes:
an inclined pin part having a groove;
a pole, one end of the pole having a protrudent structure, the shape of the protrudent structure corresponding to that of the groove, the protrudent structure embedded into the groove to allow the pole to be connected with the inclined pin part; and
a third screw passing through one of the through holes and screwing the pole to the ejecting plate.

6. The mold according to claim 4, wherein the second mold core has a plurality of conical through holes for guiding the molding elements.

7. The mold according to claim 4, wherein each of the molding elements comprises a pin and a sleeve, one end of the pin is fixed to the base, the sleeve is sleeved on the pin, and one end of the sleeve is fixed to the ejecting plate.

8. The mold according to claim 1, further comprising a mold core retaining block and a fourth screw, the mold core retaining block screwed to the mold core base via the fourth screw, the mold core retaining block located adjacent to the second mold core to allow the second mold core to be tightly against the mold core base.

9. A mold disassembling method for disassembling the mold according to claim 1, the mold disassembling method comprising the following steps of:
removing the first mold core;
unscrewing the first screws;
separating the mold core base from the base and providing a plurality of cushion blocks to be disposed between the mold core base and the base; and
disassembling the second mold core from the mold core base.

10. The mold disassembling method according to claim 9, wherein the base comprises a base plate, an ejecting plate, and a plurality of molding elements, the ejecting plate is disposed at the base plate, the molding elements pass through the base plate, the ejecting plate, the mold core base, and the second mold core, and when the cushion blocks are disposed between the mold core base and the base, ends of the molding elements adjacent to the second mold core are embedded into the mold core base.

11. The mold disassembling method according to claim 9, wherein the base has a plurality of through holes, the mold further includes a plurality of ejecting inclined pins passing through the ejecting plate, the mold core base, and the second mold core, each of the ejecting inclined pins includes an inclined pin part, a pole, and a third screw, the third screw passes through one of the through holes and screws the pole to the ejecting plate, and the mold disassembling method further comprises the following steps of:
unscrewing and removing the third screws from the through holes to allow the inclined pin parts to partly protrude from the second mold core; and
taking out the inclined pin parts and the poles from the side adjacent to the second mold core.

12. The mold disassembling method according to claim 9, wherein the mold is used for molding a plastic element, and the height of the cushion blocks is equal to the sum of that of the second mold core and the plastic element.

13. The mold disassembling method according to claim 9, wherein the mold further includes at least one mold core retaining block and at least one fourth screw, the mold core retaining block is screwed to the mold core base via the fourth screw, the mold core retaining block is located adjacent to the second mold core to allow the second mold core to be tightly against the mold core base, and before the step of disassembling the second mold core from the mold core base, the mold disassembling method further comprises the following steps of:
unscrewing the fourth screw; and
removing the mold core retaining block from the mold core base.
